(19) United States
(12) Patent Application Publication
(10) Pub. No.: US 2016/0001312 A1
(43) Pub. Date: Jan. 7, 2016

(54) MULTIPLE INPUT DIP TUBE

(71) Applicant: Stephen F.C. Geldard, San Jose, CA (US)

(72) Inventor: Stephen F.C. Geldard, San Jose, CA (US)

(21) Appl. No.: 14/323,873

(22) Filed: Jul. 3, 2014

(51) Int. Cl. B05B 11/00

(52) U.S. Cl. CPC B05B 11/0089

(57) ABSTRACT

A dip tube includes a main dip tube section and a plurality of input sections. Each input section in the plurality of input sections includes a reservoir region capped by a hydrophilic membrane. The plurality of input sections are joined to the main dip tube section at a junction.

### BACKGROUND

Spray bottles, pump action containers and similar hand held consumer and industrial fluid delivery devices typically include a dip tube to transport fluid from the bottom of a container to a nozzle head. The fluid can be, for example, a household cleaning solution, plant fertilizer, perfume, suntan lotion and so on. The fluid enters the dip tube at or near a bottom of a container holding the fluid. The fluid is pumped through the dip tube, then to and out the nozzle head to a desired location.

### BRIEF DESCRIPTION OF THE DRAWINGS

FIG. 1 shows a multiple input dip tube in accordance with an implementation.

FIG. 2 shows the multiple input dip tube shown in FIG. 1 with the inputs extended in accordance with an implementation.

FIG. 3 shows a multiple input dip tube within a container and connected to a pump nozzle head in accordance with an implementation.

FIG. 4 shows a multiple input dip tube within a tilted container and connected to a pump nozzle head in accordance with an implementation.

FIG. 5 shows a multiple input dip tube within where each input has a membrane, a reservoir region and a venturi in accordance with an implementation.

FIG. 6 shows an input that has a membrane, a reservoir region and a venturi in accordance with an implementation.

FIG. 7 shows a square cross section of a reservoir region shape in accordance with an implementation.

FIG. 8 shows a circular cross section of a reservoir region shape in accordance with an implementation.

FIG. 9 shows a multiple input dip tube within a container having various potential configurations for connection to a pump nozzle head in accordance with an implementation.

FIG. 10 shows a multiple input dip tube in accordance with another implementation.

### DESCRIPTION OF THE EMBODIMENT

A single input dip tube is only able to capture liquid from one location within a container. This can be problematic, for example, when the container is tilted and the fluid pools at a location below a current input location of the dip tube. A dip tube with multiple inputs can allow more efficient use of fluid within a container, especially when the container is tilted during use.

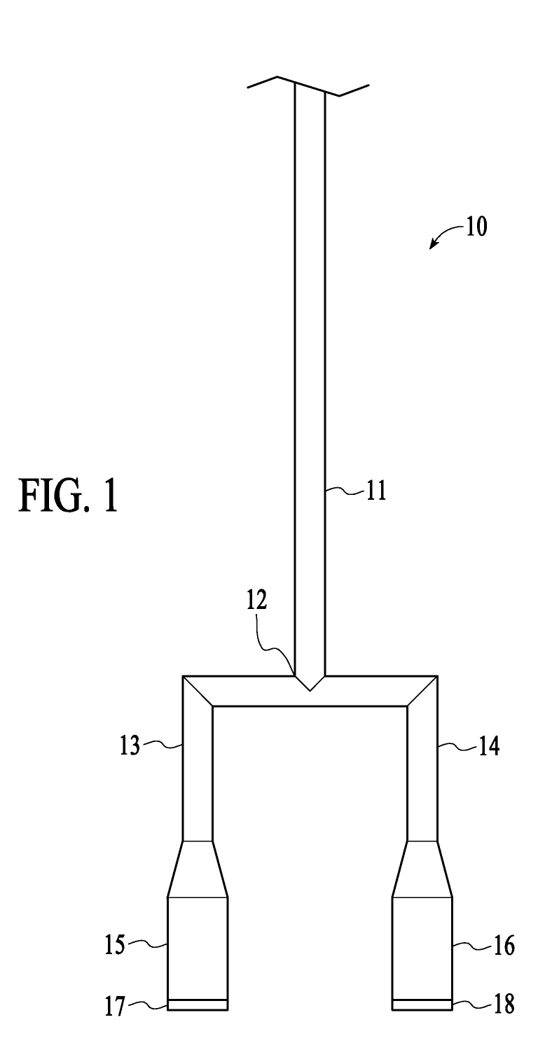

For example, FIG. 1 shows a dip tube 10 with multiple inputs. A main dip tube section 11 at a junction 12, divides into an input section 13 and an input section 14. For example, dip tube 10 is formed or molded in one piece using a flexible material, such as high-density polyethylene (HDPE) plastic.

A hydrophilic membrane 17 prevents air intake to a reservoir region 15 when fluid does not reach to a location of hydrophylic membrane 17. When fluid does reach to the location of hydrophilic membrane 17, fluid can pass through hydrophilic membrane 17 to reach reservoir region 15. Likewise, a hydrophilic membrane 18 prevents air intake to a reservoir region 16 when fluid does not reach to a location of hydrophylic membrane 18. When fluid does reach to the location of hydrophilic membrane 18, fluid can pass through hydrophilic membrane 18 to reach reservoir region 16.

Hydrophilic membrane 17 and hydrophilic membrane 18 each allow low viscosity fluid across their surface while at the same time blocking any air from entering the system. The fluid is essentially degassed. Hydrophilic membranes are manufactured by General Electric (GE) and other companies in various materials including Nylon, Mixed Cellulose Esters (MCE Nitrocellulose), Cellulose Acetate, polytetrafluoroethylene (PTFE), Polysulphone and so on.

Hydrophilic membrane 17 and hydrophilic membrane 18 decrease fluid flow into input section 13 and input section 14, respectively. The increased intake area, and thus the increased intake capability, of reservoir region 15 and reservoir region 16 is implemented to compensate for the decreased fluid flow through hydrophilic membrane 17 and hydrophilic membrane 18, respectively. While FIG. 1 shows a cross section of input section 13 being increased at reservoir region 15 and a cross section of input section 14 being increased at reservoir region 16 in order to compensate for the decreased fluid flow through hydrophilic membrane 17 and hydrophilic membrane 18, respectively, this is not necessary for applications where fluid flow through hydrophilic membrane 17 and hydrophilic membrane 18 is sufficient without increasing the cross sections at reservoir regions 15 and reservoir region 16. In cases where the cross sections at reservoir regions 15 and reservoir region 16 are not widened, the cross sections at reservoir regions 15 and reservoir region 16 can remain the same as for other locations within input section 13 and input section 14, respectively.

When reservoir region 15 and reservoir region 16 are both immersed in fluid and thus able to draw fluid out of a container, total flow through main dip tube section 11 increases which allows for a more even spray of a connected spray nozzle.

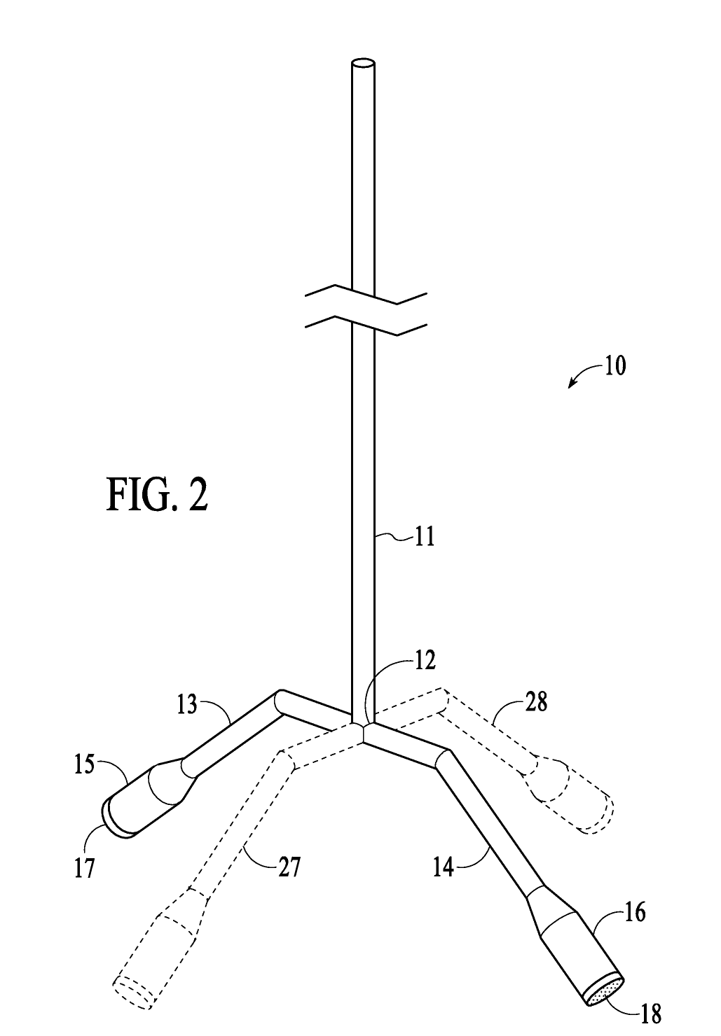

FIG. 2 shows input section 13 and input section 14 spread to the accommodate dimensions of a container. This spreading accommodates contours of a container in which dip tube 10 is placed. While FIG. 1 shows dip tube 10 having two inputs, additional inputs can be added. This is illustrated in FIG. 2 by dashed lines indicating where an input region 27 and an input region 28 could be added.

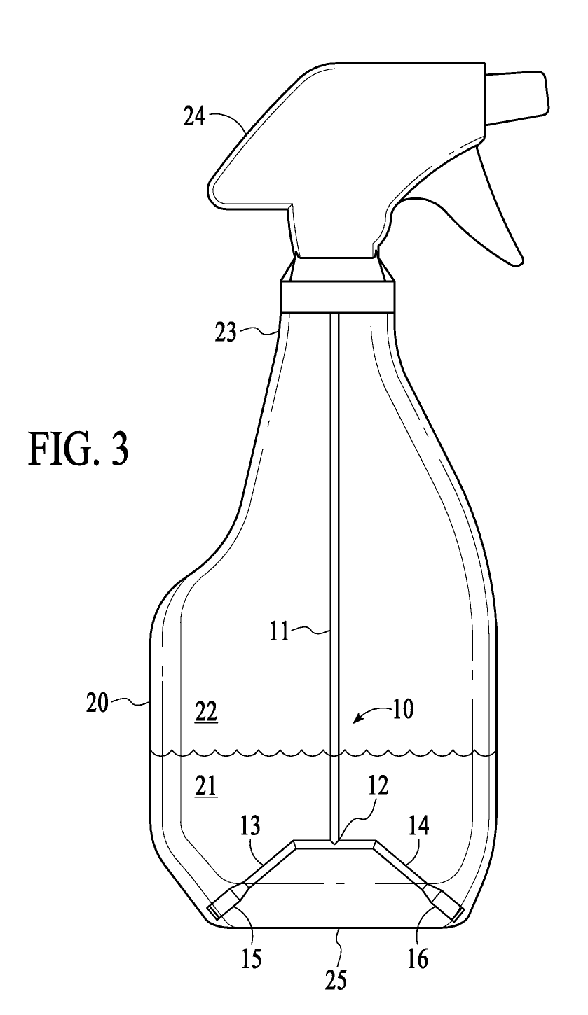

FIG. 3 shows main dip tube section 11 placed in a container 20. As dip tube reaches a bottom 25 of container, input section 13 and input section 14 are spread to reach bottom corners of container 20. When container 20 is upright both the multiple input section 13 and input section 14 are spread as the bottom of reservoir region 15 and reservoir region 16 encounter bottom 25 of container 20 and main dip tube section 11 continues to be pushed down. Pump nozzle 24 is attached to a top opening section 23 of container 20 and to main dip tube section 11. Container 20 is partially filled with fluid 21. A remainder of volume of container 20 is filled with air 22. The size, shape and flexibility of dip tube 10 is configured to allow easy entrance to container 20 through top opening section 23.

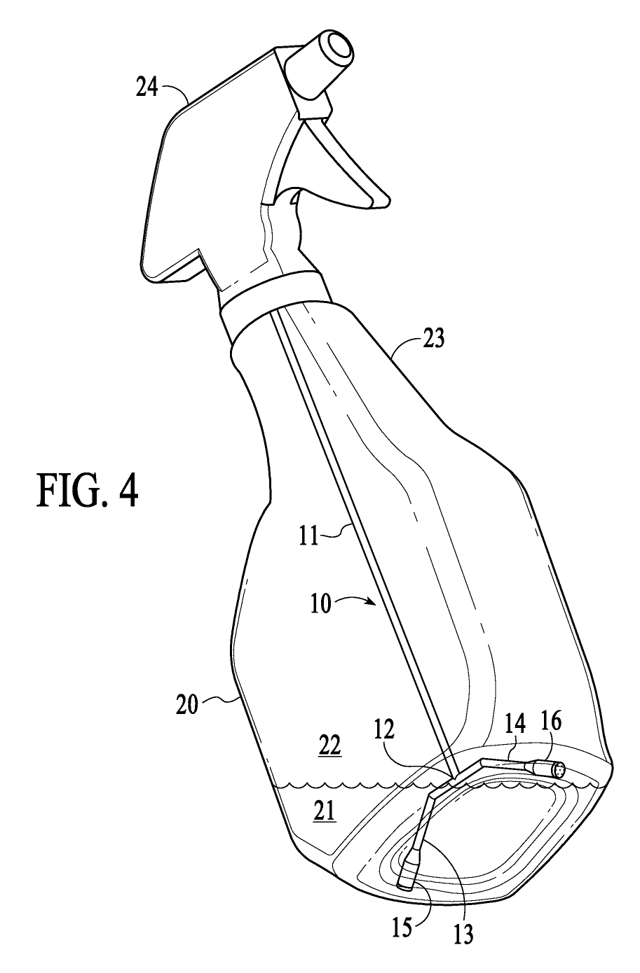

As fluid level is decreased and container 20 is tilted, for example when used, fluid 21 may cover one but not both of reservoir region 15 and reservoir region 16. This illustrated by FIG. 4 where container 10 has been tilted so that fluid 21 covers reservoir region 15 but not reservoir region 16. A pump nozzle head 24 pumps fluid through dip tube 10, hydrophilic membrane 18 prevents air 22 from entering reservoir region 16. Fluid 21 pass through hydrophilic membrane 17 into reservoir region 15, through input section to main dip tube section 11 and out of container 20 through pump nozzle head 24.

This allows container 20 to be held at an angle than change fluid angle and level within container 20 while still providing fluid through dip tube 10 to pump nozzle head 24. This also allows fluid 21 to be used efficiently and completely while simultaneously adding flexibility at allowable angles container 20 can be held as fluid level decreases.

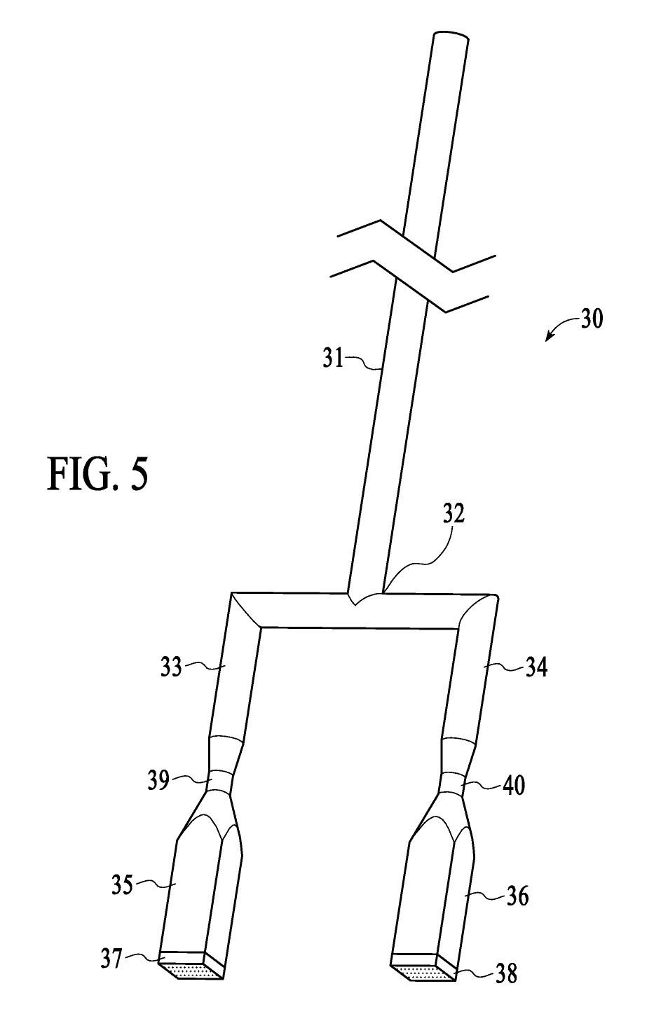

FIG. 5 shows a multiple input dip tube within where each input section has a venturi section where a diameter of the input section is narrowed. Specifically, FIG. 5 shows a dip tube 30 with multiple inputs. A main dip tube section 31 at a junction 32, divides into an input section 33 and an input section 34. A hydrophilic membrane 37 prevents air intake to a reservoir region 35 when fluid does not reach to a location of hydrophylic membrane 37. When fluid does reach to the location of hydrophilic membrane 37, fluid can pass through hydrophilic membrane 37 to reach reservoir region 35. Likewise, a hydrophilic membrane 38 prevents air intake to a reservoir region 36 when fluid does not reach to a location of hydrophylic membrane 38. When fluid does reach to the location of hydrophilic membrane 38, fluid can pass through hydrophilic membrane 38 to reach reservoir region 36.

A venturi that includes a narrow section 39 of input section 33 causes a pressure drop that increases the flow of fluid through input section 33 and compensates for the loss of flow across membrane 37 into reservoir region 35. The venturi also lessens turbulence, resistance and back flow as fluid crosses hydrophilic membrane 37 into reservoir region 35. Likewise, a venturi that includes narrow section 40 of input section 34 causes a pressure drop that increases the flow of fluid input 34 and compensates for the loss of flow across membrane 38 into reservoir region 36. This venturi also lessens turbulence, resistance and back flow as fluid crosses hydrophilic membrane 38 into reservoir region 36.

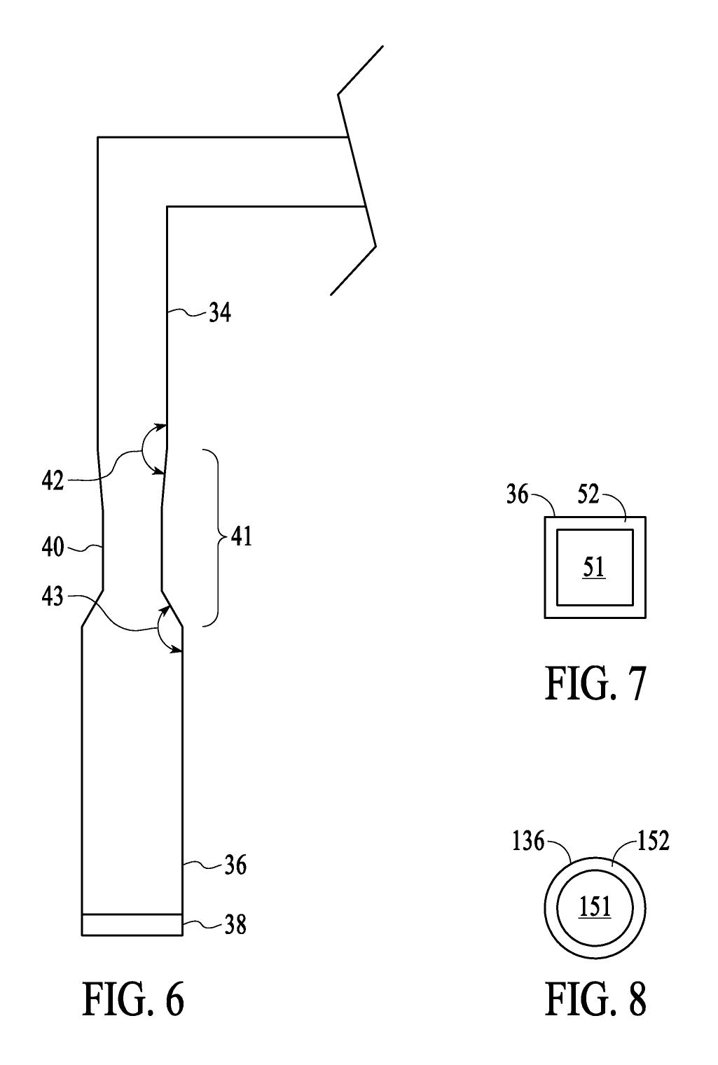

FIG. 6 provides additional information about a venturi 41 that includes narrow section 40. For example, in constructing venturi 41, an angle 42 is approximately 175 degrees and an angle 43 is approximately 60 degrees.

FIG. 7 shows an example of a cross section shape for reservoir region 36. In the example shown in FIG. 7, the cross section of reservoir region 36 is shown to have square corners with a wall region 52 and an inner passage 51. Wall region 52 can, for example, include either a waterproof adhesive or a waterproof adhesive and gasket where membrane 38 is joined to reservoir region 36. A square shape at the open end of reservoir region 36 can allow for more efficient use of membrane material when manufacturing.

FIG. 8 shows an alternative example of a cross section shape for a reservoir region. In the example shown in FIG. 8, the cross section of a reservoir region 136 is rounded with a wall region 152 and an inner passage 151. Wall region 152 can also, for example, include either a waterproof adhesive or a waterproof adhesive and gasket where a membrane is joined to reservoir region 136.

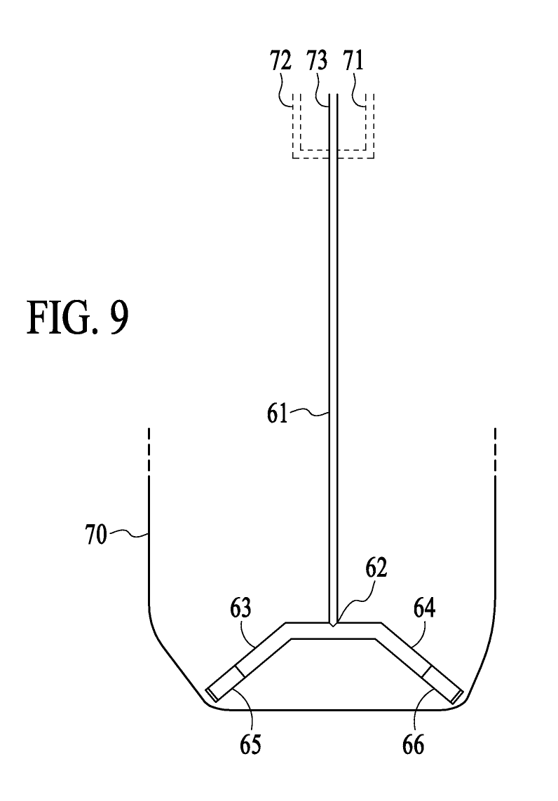

FIG. 9 shows a multiple input main dip tube section 61 within a container 70. A main dip tube section 61 at a junction 62, divides into an input section 63 and an input section 64. A hydrophilic membrane 65, shaped as a cap, prevents air intake to input section 63 when fluid does not reach to a location of hydrophylic membrane 65. When fluid does reach to the location of hydrophilic membrane 65, fluid can pass through hydrophilic membrane 65 to reach input section 63. Likewise, a hydrophilic membrane 66 prevents air intake to input section 64 when fluid does not reach to a location of hydrophylic membrane 68. When fluid does reach to the location of hydrophilic membrane 66, fluid can pass through hydrophilic membrane 66 to reach input section 64. For example, in the implementation shown in FIG. 9, all of input section 63 acts a reservoir and all of input section 64 acts as another reservoir.

Various configuration options at a top of main dip tube section 61 are illustrated by FIG. 9. A straight configuration 73 is issued when a pump nozzle to be connected to main dip tube section 61 is configured to receive a straight configuration. When a pump nozzle is configured to receive an offset dip tube configuration, the top of main dip tube section 61 is configured to conform to the expected offset such as illustrated by an offset configuration 71 or an offset configuration 72.

While various embodiments of a dip tube with two inputs have been shown herein, the number of inputs can differ dependent upon the intended uses and preferences of the user or designer.

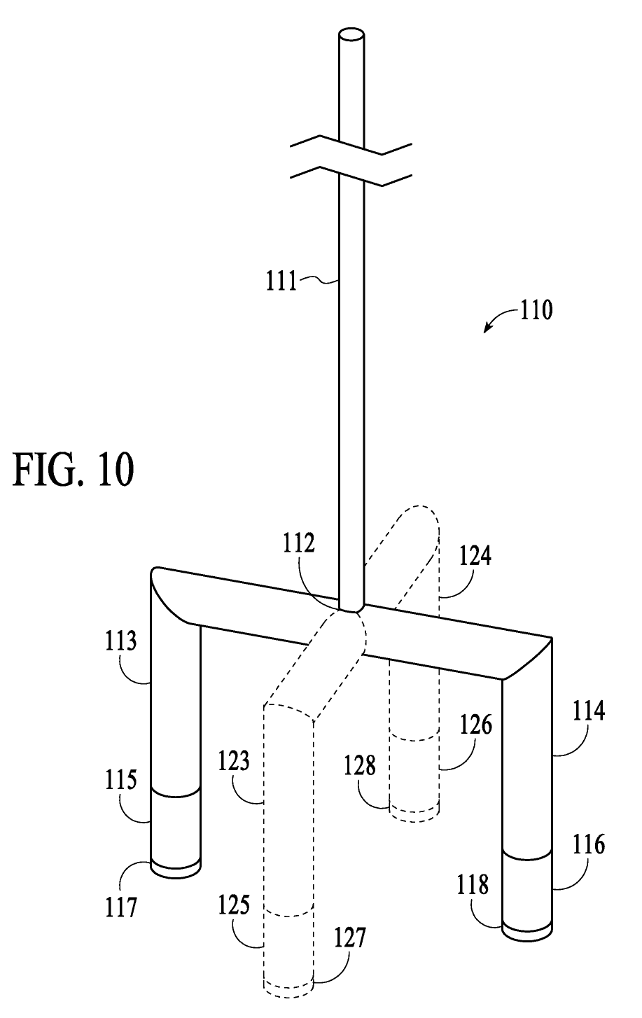

For example, FIG. 10 shows a dip tube 110 with four inputs. A main dip tube section 111 at a junction 112, divides into an input section 113, an input section 114, an input section 123 and an input section 124. A hydrophilic membrane 117 prevents air intake to a reservoir region 115 when fluid does not reach to a location of hydrophylic membrane 117. When fluid does reach to the location of hydrophilic membrane 117, fluid can pass through hydrophilic membrane 117 to reach reservoir region 115. Likewise, a hydrophilic membrane 118 prevents air intake to a reservoir region 116 when fluid does not reach to a location of hydrophylic membrane 118. When fluid does reach to the location of hydrophilic membrane 118, fluid can pass through hydrophilic membrane 118 to reach reservoir region 116.

Additional optional input regions are shown in dashed lines. Specifically, a hydrophilic membrane 127 prevents air intake to a reservoir region 125 when fluid does not reach to a location of hydrophylic membrane 127. When fluid does reach to the location of hydrophilic membrane 127, fluid can pass through hydrophilic membrane 127 to reach reservoir region 125. Likewise, a hydrophilic membrane 128 prevents air intake to a reservoir region 126 when fluid does not reach to a location of hydrophylic membrane 128. When fluid does reach to the location of hydrophilic membrane 128, fluid can pass through hydrophilic membrane 128 to reach reservoir region 126.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A dip tube comprising:
a main dip tube section;
a first input section, the first input section having a first reservoir region capped by a hydrophilic membrane; and,
a second input section, the second input section having a second reservoir region capped by a second hydrophilic membrane;
wherein the first input section and the second input section are joined to the main dip tube section at a junction.

2. A dip tube as in claim 1:
wherein the first input section has a first venturi region where a diameter of the first input section is decreased; and,
wherein the second input section has a second venturi region where a diameter of the second input section is decreased.

3. A dip tube as in claim 1:
wherein a cross section of the first input section where the first reservoir region is capped by the first hydrophilic membrane region has approximately square corners; and,
wherein a cross section of the second input section where the second reservoir region is capped by the second hydrophilic membrane region has approximately square corners.

4. A dip tube as in claim 1:
wherein a cross section of the first input section where the first reservoir region is capped by the first hydrophilic membrane region is rounded; and,
wherein a cross section of the second input section where the second reservoir region is capped by the second hydrophilic membrane region is rounded.

5. A dip tube as in claim 1 additionally comprising:
a third input section, the third input section having a third reservoir region capped by a third hydrophilic membrane;
wherein the third input section is joined to the main dip tube section at the junction.

6. A dip tube as in claim 1 additionally comprising:
a third input section, the third input section having a third reservoir region capped by a third hydrophilic membrane, wherein a cross section of the third input section is increased at the third reservoir region; and,
a fourth input section, the fourth input section having a fourth reservoir region capped by a fourth hydrophilic membrane, wherein a cross section of the fourth input section is increased at the fourth reservoir region;
wherein the third input section and the fourth input section are joined to the main dip tube section at the junction.

7. A dip tube as in claim 1:
wherein a cross section of the first input section is increased at the first reservoir region; and,
wherein a cross section of the second input section is increased at the second reservoir region.

8. A dip tube comprising:
a main dip tube section;
a plurality of input sections, each input section in the plurality of input sections comprising:
a reservoir region capped by a hydrophilic membrane, wherein a cross section of the input section is increased at the reservoir region;
wherein the plurality of input sections are joined to the main dip tube section at a junction.

9. A dip tube as in claim 8:
wherein the input section has a venturi region where a diameter of the input section is decreased.

10. A dip tube as in claim 8:
wherein a cross section of the input section where the reservoir region is capped by the hydrophilic membrane region has approximately square corners.

11. A dip tube as in claim 8:
wherein a cross section of the input section where the reservoir region is capped by the hydrophilic membrane region is rounded.

12. A fluid delivery device comprising:
a container;
a pump nozzle head;
a dip tube attached to the pump nozzle head, the dip tube comprising:
a main dip tube section;
a plurality of input sections, each input section in the plurality of input sections comprising:
a reservoir region capped by a hydrophilic membrane;
wherein the plurality of input sections are joined to the main dip tube section at a junction; and,
wherein each input section in the plurality of input sections extends at least approximately to a bottom of the container.

13. A fluid delivery device as in claim 12:
wherein the input section has a venturi region where a diameter of the input section is decreased.

14. A fluid delivery device as in claim 12:
wherein a cross section of the input section where the reservoir region is capped by the hydrophilic membrane region has approximately square corners.

15. A fluid delivery device as in claim 12:
wherein a cross section of the input section where the reservoir region is capped by the hydrophilic membrane region is rounded.

16. A fluid delivery device as in claim 12:
wherein a cross section of the input section is increased at the first reservoir region.
